(19) United States
(12) Patent Application Publication
(10) Pub. No.: US 2024/0416576 A1
(43) Pub. Date: Dec. 19, 2024

(54) ENGINEERING CONSTRUCTION WITH GEOGRID AND GEOTEXTILE, METHODS OF PRODUCING AND PROVIDING SUCH AND ITS USE

(71) Applicant: TENSAR TECHNOLOGIES LIMITED, Shadsworth, Blackburn, Lancashire (GB)

(72) Inventors: Andrew Curson, Burnley (GB); Joe Cavanaugh, Cumming, GA (US); Michal Golos, Blackburn (GB); Jacek Kawalec, Blackburn (GB)

(73) Assignee: TENSAR TECHNOLOGIES LIMITED, Shadsworth, Blackburn, Lancashire (GB)

(21) Appl. No.: 18/274,142

(22) PCT Filed: Jan. 27, 2022
(86) PCT No.: PCT/GB2022/050216

§ 371 Date: Jul. 25, 2023

(30) Foreign Application Priority Data
Jan. 28, 2021 (GB) 2101168.9

(51) Int. Cl. B29C 55/10; E01C 11/00; E01C 11/18

(52) U.S. Cl. CPC B29C 55/10; E01C 11/005; E01C 11/185

(57) ABSTRACT

An engineering construction comprising an integral multiaxial polymer geogrid at least partially embedded in a bound aggregate layer, wherein a geotextile is affixed to the geogrid, methods for producing such constructions, the constructions having improved fatigue life or reduced depth, and the use of multiaxial polymer geogrids to improve the fatigue life and/or reduce the depth of an engineering construction.

### FIELD OF THE INVENTION

The present invention relates to an improved engineering construction comprising a multiaxial geogrid and a bound aggregate material. In particular, the bound aggregate material is asphalt concrete. The present invention also relates to the use of a multiaxial geogrid to improve the fatigue life and/or reduce the thickness of a bound aggregate layer, as well as methods for producing an improved engineering construction, and improving the fatigue life and/or reducing the thickness of a bound aggregate layer.

### BACKGROUND

Asphalt concrete is a well-known construction material comprising a mineral aggregate set into a petroleum-based binder (bitumen, also referred to as asphalt). A number of approaches for applying asphalt are known in the art, generally involving reducing the viscosity of the binder (e.g. by heating, addition of volatile solvents, and/or emulsification), mixing the ‘loose’ binder with the aggregate, and depositing the mixture. The binder is then allowed to set, immobilising the aggregate and forming the composite. The mixture is usually subject to compression prior to and/or during the setting step.

Applications of asphalt concrete include paved surfaces. It finds particular application in the context of pavements for traffic, both foot and vehicular, due to its low cost, ease of application, and advantageous physical properties. However, asphalt concrete is degraded overtime due to the stress of repeated loading and unloading as traffic passes over it, resulting in its eventual failure. This parameter is often measured as ‘fatigue life’: the number of cycles of loading and unloading that a material can withstand before failing.

Although asphalt concrete has many beneficial qualities, its eventual failure means that it will require replacement, preventing use of the paved surface for a time. Reducing the frequency with which the asphalt concrete requires replacement also reduces the quantities of materials and energy required to maintain the paved surface during its lifetime. It is therefore desirable to increase the fatigue life of the asphalt concrete.

Alternatively, it is desirable to provide asphalt concrete of a reduced thickness, as compared to asphalt concretes known in the art (e.g. those that are unreinforced or which include uniaxial or biaxial geogrids), while maintaining at least the same fatigue life. Reducing the thickness of the asphalt concrete reduces the quantity of asphalt required, the energy needed to prepare it, and the time taken to lay it.

As with any mature technology, a number of approaches have been developed to improve the fatigue life of asphalt concrete. Primarily these approaches use other materials in combination with the binder and aggregate to form composites.

S. F. Brown, J. M. Brunton, D. A. B. Hughes, and B. V. Brodrick describe (in “Polymer Grid Reinforcement of Asphalt”, presented to the Annual Meeting of the Association of Asphalt Paving Technologists, San Antonio, Texas, 11-13 Feb. 1985) how the reinforcement of asphalt concrete with biaxial polymer geogrids leads to improved resistance to rutting, reflection cracking, and fatigue cracking. The resistance to fatigue cracking was only established in terms of the propagation of existing cracks, not crack initiation. For beams with a depth of 90 mm, fatigue life was estimated to increase by a factor of between two (when the grid is placed a quarter of the way up the sample) and 10 (when the grid is placed near the bottom of the sample) compared to beams without a geogrid.

GB 2,225,048 B describes the reinforcement of paved surfaces with a geocomposite of a biaxial geogrid laminated to a fabric.

I. M. Arsenie, C. Chazallon, J-L. Duchez, and P. Hornych describe (in “Laboratory Characterisation of the Fatigue Behaviour of a Glass Fibre Grid-Reinforced Asphalt Concrete using 4PB Tests”, Road Materials and Pavement Design, 18:1, 168-180) how glass fibre grids may be used to improve resistance to fatigue cracking by a factor of between 1.39 and 1.75 compared to unreinforced beams. The beams tested had a thickness of 150 mm, with glass fibre grids placed at depths of 50 and 100 mm, and could not be made thinner without compromising bonding and compaction.

N. Sudarsanan, A. Arulrajah, R. Karpurapu, and V. Amrithalingam describe (in “Fatigue Performance of Geosynthetic-Reinforced Asphalt Concrete Beams”, J. Mater. Civ. Eng., 2020, 32(8): 04020206) a number of materials for reinforcing asphalt concrete. Sample beams of 100 mm depth were created, reinforced at a depth of 30 mm from the base with one of jute, coir, or Fibreglass grid. The sample beams were tested in stress-controlled mode at temperatures of 10 to 30° C. by a four point bending test, with failure being defined as sample rupture or a set displacement value of 20 mm being reached. Fatigue life improvement factors (compared to unreinforced beams) of 1.5 to 3.6 times for jute, of 1.4 to 4 times for coir, and 3.2 to 11.6 times for fibreglass being determined. For each sample, fatigue life improved with increasing temperature.

The present invention seeks to address one or more of the problems associated with existing approaches for underpinning asphalt concretes, whether mentioned above or otherwise, and provide an improved engineering construction with improved fatigue life and/or reduced thickness.

### SUMMARY OF THE INVENTION

A first aspect of the present invention relates to an engineering construction comprising a multiaxial polymer geogrid at least partially embedded in a bound aggregate layer. The geogrid may be an integral geogrid (i.e. a geogrid formed from a single sheet of a polymeric starting material, in contrast to some prior art geogrids which are formed of multiple elements, such as fibres or straps, which are arranged into a geogrid and affixed to one another). A geotextile may be affixed to the geogrid. By at least partially embedded, it is meant that the elongate elements of the geogrid, being approximately rectangular in cross-section, are surrounded on at least three sides by the bound aggregate. The geogrid may be completely embedded in the bound aggregate layer, by which it is meant that the elongate elements of the geogrid are surrounded on all sides by the bound aggregate layer. By at least partially embedding a multiaxial polymer geogrid into the bound aggregate layer, the fatigue life of the engineering construction is improved, as demonstrated in the Examples of the present application, summarised in FIG. 4. This improvement in the fatigue life allows the engineering construction to have a longer lifetime before needing to be replaced compared to an equivalent engineering construction in the absence of the multiaxial geogrid, with consequent reductions in energy and material use. It is thought that by at least partially embedding the multiaxial geogrid within the bound aggregate layer a number of other mechanical properties (such as compressive strength, tensile strength, and/or creep strength) may also be improved compared to a bound aggregate in the absence of a multiaxial geogrid. Generally, the mechanical properties of a geoengineering construction are generally proportional to the thickness of its bound aggregate layer. Therefore, a geoengineering construction of the present invention (in which a multiaxial geogrid is at least partially embedded in the bound aggregate layer) may have mechanical properties equal to those of known engineering constructions (in the absence of a multiaxial geogrid) with a thicker bound aggregate layer. In other words, when designing an engineering construction requiring particular mechanical properties, the incorporation of a multiaxial geogrid into the bound aggregate layer allows for the thickness of the bound aggregate layer to be reduced. This has benefits in terms of the quantity of bound aggregate required and the energy and time needed to process it. For example, to achieve a given fatigue life, an engineering construction of the present invention (in which a multiaxial geogrid is at least partially embedded in the bound aggregate layer) may have a thinner bound aggregate layer than known engineering constructions (in the absence of a multiaxial geogrid).

The geogrid may be a triaxial geogrid. The highly isotropic nature of triaxial geogrids ensures even and efficient distribution of forces around engineering constructions containing them.

The geogrid may have a radial secant stiffness of 0.5% strain of at least 100 kN/m, preferably of from 200 to 800 kN/m more preferably of from 220 to 700 kN/m, most preferably of from 250 to 600 kN/m.

The geogrid may have a radial secant stiffness at 2% strain of at least 80 kN/m, preferably of from 150 to 600 kN/m more preferably of from 170 to 500 kN/m, most preferably of from 200 to 450 kN/m.

The geogrid may have a radial secant stiffness ratio (dimensionless) of at least 0.5 preferably of from 0.6 to 0.95, most preferably of from 0.70 to 0.90, most preferably of from 0.75 to 0.85.

The geogrid may have a junction efficiency of at least 90% preferably at least 95%, more preferably of at least 97%, most preferably of at least 99%, for example of 100%.

The geogrid may have a pitch (preferably hexagon pitch) of at least 30 mm, preferably of from 40 to 150 mm, more preferably of from 50 to 140, most preferably of from 65 to 125 mm.

The geogrid (in the absence of the geotextile element) may have a product weight of at least 0.100 kg/m², preferably of from 0.120 to 0.400 kg/m², more preferably of from 0.150 to 0.350 kg/m², most preferably of from 0.170 to 0.310 kg/m².

The geogrid may have aspect ratio of at least 0.8, preferably of at least 0.9, more preferably of at least 1.0, and most preferably of at least 1.1. It will be understood that the term “aspect ratio” refers to the ratio of the thickness, or height, of the elongate element cross section to the width of the elongate element cross section, with thickness referring to the dimension of the elongate element that is normal to the plane of the geogrid and width referring to the dimension of the elongate element that is in the plane of the geogrid and normal to the length of the elongate element spanning adjacent nodes. Thickness and width are typically measured at the mid-point of the elongate element, i.e. half-way between the nodes, providing that the elongate element dimensions are relatively uniform. The regions where the elongate elements intersect the nodes are excluded from the measurements for determining aspect ratio. If the elongate element dimensions are not uniform, then the aspect ratio should be taken as the value that occurs most frequently along the elongate element's length between nodes, for example by constructing a histogram of aspect ratio along the length of each set of parallel elongate elements in the grid structure to determine the value of greatest frequency. Both the thickness and width of the elongate elements and hence the aspect ratio values may vary along the length of the elongate elements, especially as they pass through connecting nodes.

The geogrid may have elongate element thickness, or height, of at least 1.0 mm, preferably of at least 1.1 mm, more preferably of at least 1.2 mm, and most preferably of at least 1.3 mm.

The geogrid may have a substantially constant thickness. In such embodiments, the thicknesses of the elongate elements and nodes of the geogrid are about the same. Such thickness ensures better contact between the geogrid and the surface below it.

The engineering construction may further comprise a geotextile affixed to the multiaxial geogrid. This forms a geocomposite comprising the geotextile and the geogrid and beneficially prevents the bound aggregate from passing entirely through the apertures in the geogrid during deposition. It also improves contact of the geogrid with the surface below it. The geotextile may be affixed to the geogrid by thermal bonding. Other suitable methods include adhesives, solvent bonding, ultrasonic welding, and tying. Geotextiles are particularly beneficial when combined with geogrids of constant thickness as the strength of the bond between the components is improved.

The geotextile element on its own, excluding the geogrid may have a product weight of at least 0.080 kg/m², preferably of from 0.100 to 0.200 kg/m², more preferably of from 0.110 to 0.180 kg/m², most preferably of from 0.120 to 0.150 kg/m². Alternatively, the geotextile element may have a product weight of from 0.03 to 0.4 kg/m².

The geogrid may have an axis to which elongate elements comprising the geogrid run parallel to which extends in the machine direction. Conventionally, the production of integral, multiaxial geogrids involves a step of stretching a polymeric starting sheet. It will be understood that the machine direction (MD) is the direction in which the sheet passes through the machinery used to stretch the polymeric starting sheet and the transverse direction (TD) is perpendicular to MD. In other words, the geogrid may comprise a set of elongate elements which have, during manufacture of the geogrid, been stretched in the machine direction. Multiaxial geogrids, especially triaxial geogrids, with a set of elongate elements running in the machine direction are less vulnerable to edge rolling effects (induced during production or when rolled up for storage) than those with sets of elongate elements running only in other directions, thereby enabling the geogrids to lie flat and have better contact with the substrate and bound aggregate when unrolled.

The engineering construction may further comprises at least one additional layer selected from a subgrade, a base course, a partially milled bound aggregate and a levelling course. In one embodiment, the engineering construction further comprises a partially milled bound aggregate. In a further embodiment, the engineering construction further comprises a partially milled bound aggregate and a levelling course. In a yet further embodiment, the engineering construction further comprises a base course, a partially milled bound aggregate, and a levelling course. In a still further embodiment, the engineering construction further comprises a subgrade, a base course, a partially milled bound aggregate, and a levelling course. In an alternative embodiment, the engineering construction further comprises a subgrade and a base course. In the preceding embodiments, the at least one additional layer may be located below the multiaxial geogrid and/or the additional layers may be arranged in the order provided (with the earliest mentioned additional layer being lowermost). These additional layers impart enhanced physical characteristics to the engineering construction, for example, the subgrade and base course may compensate for unfavourable geology, while the levelling course ensures that the geogrid is held in a planar conformation, ensuring efficient force transfer within it. The partially milled bound aggregate may be in places where the engineering construction is formed through the refurbishment of a pre-existing construction.

The engineering construction may further comprise a surface coating, such as a tack coat, between the geogrid and the at least one additional layer. In embodiments comprising multiple additional layers, the surface coating may be located between the uppermost additional layer and the geogrid. Surface coatings can impart a number of beneficial effects on the engineering construction. For example, a tack coat enhances the adhesion of the geogrid (and the bound aggregate layer, where it contacts the at least one additional layer through apertures in the geogrid) to the at least one additional layer. The use of a tack coat is particularly beneficial when using geocomposites including a multiaxial geogrid and a geotextile, as the geotextile (adjacent to the uppermost additional layer, preferably the partially milled layer) increases contact with the tack coat, which may permeate into the geotextile to further increase adhesion of the geocomposite to the additional layer.

The bound aggregate layer may be an asphalt concrete. Asphalt concrete being a composite material of aggregate bound in a bituminous matrix. The particle size of the aggregate may be in the range of 5 to 35 mm, preferably 10 to 32 mm. Alternatively, the particle size of the aggregate may be up to 11 mm, up to 16 mm, up to 22 mm, or up to 32 mm. The average distance between the multiaxial geogrid and the surface of the aggregate is in the range of 300 mm to 60 mm, preferably 250 mm to 60 mm, more preferably 200 mm to 60 mm, yet more preferably 150 to 60 mm, most preferably 100 mm to 60 mm. These distances can be equated to the depth of the geogrid below the surface of the bound aggregate layer. It will be understood that the average distance between the surface of the bound aggregate and the geogrid is selected depending on the application that the engineering construction is used for. In embodiments where the geogrid is located at the lower surface of the bound aggregate layer, these distances are equivalent to the thickness of the bound aggregate layer. It will be understood that the minimum thickness of the bound aggregate layer required will be reduced in the present invention where a multiaxial polymer geogrid is at least partially embedded in the bound aggregate compared to an engineering construction in the absence of the geogrid.

As a non-limiting example, an engineering construction comprising asphalt concrete in the absence of a geogrid and intended to support a load of up to 2.5 million equivalent single axle loads (ESALs) of 100 kn axles requires a 160 mm thickness of asphalt concrete (underlaid by an unbound aggregate layer of 20 cm) in order to achieve an acceptable fatigue life. In an identical engineering construction further comprising a multiaxial geogrid embedded within the asphalt concrete, the thickness of the asphalt concrete may be reduced by 20 to 40 mm, while maintaining an acceptable fatigue life.

It will be understood that the foregoing features of the first aspect of the present invention may be used in conjunction with the subsequent aspects of the present invention.

A second aspect of the present invention relates to a method of producing an engineering construction comprising the steps of: a) providing a multiaxial polymer geogrid on a substrate; b) depositing an aggregate layer to at least partially embed the geogrid in the aggregate layer; and c) binding the aggregate layer to form a bound aggregate layer in which the geogrid is at least partially embedded. The geogrid may be completely embedded in the bound aggregate layer. The geogrid may be an integral geogrid (i.e. a geogrid formed from a single sheet of a polymeric starting material). A geotextile may be affixed to the geogrid.

A third aspect of the present invention relates to a method of providing an engineering construction exhibiting an improved fatigue life by at least partially embedding a multiaxial polymer geogrid in an aggregate prior to binding the aggregate to form a bound aggregate layer comprising the engineering construction. The geogrid may be completely embedded in the bound aggregate layer. By improved fatigue life, it is meant that the fatigue life of the engineering construction is improved compared to an equivalent engineering construction of the same, or greater, thickness that is absent the geogrid. The geogrid may be an integral geogrid (i.e. a geogrid formed from a single sheet of a polymeric starting material). A geotextile may be affixed to the geogrid.

A fourth aspect of the present invention relates to a method of providing an engineering construction of a reduced depth by at least partially embedding a multiaxial polymer geogrid in an aggregate prior to binding the aggregate to form a bound aggregate layer comprising the engineering construction. The geogrid may be completely embedded in the bound aggregate layer. By reduced depth, it is meant that the depth of the engineering construction, in particular the bound aggregate layer, is reduced compared to an equivalent engineering construction absent the geogrid while maintaining a fatigue life at least equal to that of the equivalent engineering construction absent the geogrid.

The geogrid may be an integral geogrid (i.e. a geogrid formed from a single sheet of a polymeric starting material). A geotextile may be affixed to the geogrid.

In any of the above methods, the geogrid may be a triaxial geogrid.

In any of the above methods, the geogrid may have radial secant stiffness at 0.5% strain of at least 100 kN/m, preferably of from 200 to 800 kN/m more preferably of from 220 to 700 kN/m, most preferably of from 250 to 600 kN/m.

In any of the above methods, the geogrid may have radial secant stiffness at 2% strain of at least 80 kN/m, preferably of from 150 to 600 kN/m more preferably of from 170 to 500 kN/m, most preferably of from 200 to 450 kN/m.

In any of the above methods, the geogrid may have radial secant stiffness ratio (dimensionless) of at least 0.5 preferably of from 0.6 to 0.95, most preferably of from 0.70 to 0.90, most preferably of from 0.75 to 0.85.

In any of the above methods, the geogrid may have junction efficiency of at least 90% preferably at least 95%, more preferably of at least 97%, most preferably of at least 99%, for example of 100%.

In any of the above methods, the geogrid may have a pitch (preferably hexagon pitch) of at least 30 mm, preferably of from 40 to 150 mm, more preferably of from 50 to 140, most preferably of from 65 to 125 mm.

In any of the above methods, the geogrid (in the absence of the geotextile) may have a product weight of at least 0.100 kg/m², preferably of from 0.120 to 0.400 kg/m², more preferably of from 0.150 to 0.350 kg/m², most preferably of from 0.170 to 0.310 kg/m².

The geogrid may have aspect ratio of at least 0.8, preferably of at least 0.9, more preferably of at least 1.0, and most preferably of at least 1.1. It will be understood that the term “aspect ratio” refers to the ratio of the thickness, or height, of the elongate element cross section to the width of the elongate element cross section, with thickness referring to the dimension of the elongate element that is normal to the plane of the geogrid and width referring to the dimension of the elongate element that is in the plane of the geogrid and normal to the length of the elongate element spanning adjacent nodes.

The geogrid may have elongate element thickness, or height, of at least 1.0 mm, preferably of at least 1.1 mm, more preferably of at least 1.2 mm, and most preferably of at least 1.3 mm.

In any of the above methods, the geogrid may have a substantially constant thickness.

In such embodiments, the thicknesses of the elongate elements and nodes of the geogrid are about the same.

In any of the above methods, a geotextile may be affixed to the multiaxial geogrid.

The geotextile element on its own, excluding the geogrid may have a product weight of at least 0.080 kg/m², preferably of from 0.100 to 0.200 kg/m², more preferably of from 0.110 to 0.180 kg/m², most preferably of from 0.120 to 0.150 kg/m². Alternatively, the geotextile element may have a product weight of from 0.03 to 0.4 kg/m².

The geogrid may have an axis to which elongate elements comprising the geogrid run parallel to which extends in the machine direction. Conventionally, the production of integral, multiaxial geogrids involves a step of stretching a polymeric starting sheet. It will be understood that the machine direction (MD) is the direction in which the sheet passes through the machinery used to stretch the polymeric starting sheet and the transverse direction (TD) is perpendicular to MD. In other words, the geogrid may comprise a set of elongate elements which have, during manufacture of the geogrid, been stretched in the machine direction. Multiaxial geogrids, especially triaxial geogrids, with a set of elongate elements running in the machine direction are less vulnerable to edge rolling effects (induced during production or when rolled up for storage) than those with sets of elongate elements running only in other directions, thereby enabling the geogrids to lie flat and have better contact with the substrate and bound aggregate when unrolled.

In any of the above methods, at least one additional layer selected from a subgrade, a base course, a partially milled bound aggregate, and a levelling course may be provided.

In one embodiment, the engineering construction further comprises a partially milled bound aggregate. In a further embodiment, the engineering construction further comprises a partially milled bound aggregate and a levelling course. In a yet further embodiment, the engineering construction further comprises a base course, a partially milled bound aggregate, and a levelling course. In a still further embodiment, the engineering construction further comprises a subgrade, a base course, a partially milled bound aggregate, and a levelling course. In an alternative embodiment, the engineering construction further comprises a subgrade and a base course. In the preceding embodiments, the at least one additional layer may be provided below the multiaxial geogrid and/or the additional layers may be arranged in the order provided (with the earliest mentioned additional layer being lowermost). The method may further comprise the step of depositing the at least one additional layer prior to providing the multiaxial polymer geogrid on the substrate. The method may further comprise the step of providing a surface coating, such as a tack coat, between the geogrid and the at least one additional layer. In embodiments comprising multiple additional layers, the surface coating may be located between the uppermost additional layer and the geogrid. Providing the surface coating may comprise depositing the surface coating on the at least one additional layer.

In any of the above methods, the bound aggregate layer may comprise asphalt concrete. Asphalt concrete being a composite material of aggregate bound in a bituminous matrix.

In any of the above methods, the particle size of the aggregate may be in the range of 5 to 35 mm, preferably 10 to 32 mm. Alternatively, the particle size of the aggregate may be up to 11 mm, up to 16 mm, up to 22 mm, or up to 32 mm.

In any of the above methods, the average distance between the multiaxial geogrid and a surface of the aggregate may be in the range of 300 to 60 mm, preferably 250 mm to 60 mm, more preferably 200 mm to 60 mm, yet more preferably 150 to 60 mm, most preferably 100 mm to 60 mm.

A fifth aspect of the present invention relates to the use of a multiaxial polymer geogrid to improve the fatigue life of an engineering construction, the engineering construction comprising the multiaxial polymer geogrid at least partially embedded in a bound aggregate layer. The geogrid may be completely embedded in the bound aggregate layer. By reduced depth, it is meant that the depth of the engineering construction, in particular the bound aggregate layer, is reduced compared to an equivalent engineering construction absent the geogrid while maintaining a fatigue life at least equal to that of the equivalent engineering construction absent the geogrid. The geogrid may be an integral geogrid (i.e. a geogrid formed from a single sheet of a polymeric starting material). A geotextile may be affixed to the geogrid.

A sixth aspect of the present invention relates to the use of a multiaxial polymer geogrid to reduce the depth of an engineering construction, the engineering construction comprising the multiaxial polymer geogrid at least partially embedded in a bound aggregate layer. The geogrid may be completely embedded in the bound aggregate layer. By improved fatigue life, it is meant that the fatigue life of the engineering construction is improved compared to an equivalent engineering construction of the same, or greater, thickness that is absent the geogrid. The geogrid may be an integral geogrid (i.e. a geogrid formed from a single sheet of a polymeric starting material). A geotextile may be affixed to the geogrid.

For any of the above uses, the geogrid may be a triaxial geogrid.

For any of the above uses, the geogrid may have radial secant stiffness at 0.5% strain of at least 100 kN/m, preferably of from 200 to 800 kN/m more preferably of from 220 to 700 kN/m, most preferably of from 250 to 600 kN/m.

For any of the above uses, the geogrid may have radial secant stiffness at 2% strain of at least 80 kN/m, preferably of from 150 to 600 kN/m more preferably of from 170 to 500 kN/m, most preferably of from 200 to 450 kN/m.

For any of the above uses, the geogrid may have radial secant stiffness ratio (dimensionless) of at least 0.5 preferably of from 0.6 to 0.95, most preferably of from 0.70 to 0.90, most preferably of from 0.75 to 0.85.

For any of the above uses, the geogrid may have junction efficiency of at least 90% preferably at least 95%, more preferably of at least 97%, most preferably of at least 99%, for example of 100%.

For any of the above uses, the geogrid may have pitch (preferably hexagon pitch) of at least 30 mm, preferably of from 40 to 150 mm, more preferably of from 50 to 140, most preferably of from 65 to 125 mm.

For any of the above uses, the geogrid (in the absence of the geotextile) may have a product weight of at least 0.100 kg/m², preferably of from 0.120 to 0.400 kg/m², more preferably of from 0.150 to 0.350 kg/m², most preferably of from 0.170 to 0.310 kg/m².

The geogrid may have aspect ratio of at least 0.8, preferably of at least 0.9, more preferably of at least 1.0, and most preferably of at least 1.1. It will be understood that the term “aspect ratio” refers to the ratio of the thickness, or height, of the elongate element cross section to the width of the elongate element cross section, with thickness referring to the dimension of the elongate element that is normal to the plane of the geogrid and width referring to the dimension of the elongate element that is in the plane of the geogrid and normal to the length of the elongate element spanning adjacent nodes.

The geogrid may have elongate element thickness, or height, of at least 1.0 mm, preferably of at least 1.1 mm, more preferably of at least 1.2 mm, and most preferably of at least 1.3 mm.

For any of the above uses, the geogrid may have a substantially constant thickness.

For any of the above uses, the engineering construction may further comprise a geotextile affixed to the multiaxial geogrid.

The geotextile element on its own, excluding the geogrid may have a product weight of at least 0.080 kg/m², preferably of from 0.100 to 0.200 kg/m², more preferably of from 0.110 to 0.180 kg/m², most preferably of from 0.120 to 0.150 kg/m². Alternatively, the geotextile element may have a product weight of from 0.03 to 0.4 kg/m².

The geogrid may have an axis to which elongate elements comprising the geogrid run parallel to which extends in the machine direction. Conventionally, the production of integral, multiaxial geogrids involves a step of stretching a polymeric starting sheet. It will be understood that the machine direction (MD) is the direction in which the sheet passes through the machinery used to stretch the polymeric starting sheet and the transverse direction (TD) is perpendicular to MD. In other words, the geogrid may comprise a set of elongate elements which have, during manufacture of the geogrid, been stretched in the machine direction. Multiaxial geogrids, especially triaxial geogrids, with a set of elongate elements running in the machine direction are less vulnerable to edge rolling effects (induced during production or when rolled up for storage) than those with sets of elongate elements running only in other directions, thereby enabling the geogrids to lie flat and have better contact with the substrate and bound aggregate when unrolled.

For any of the above uses, the engineering construction may further comprise at least one additional layer selected from a subgrade, a base course, a partially milled bound aggregate, and a levelling course. In one embodiment, the engineering construction further comprises a partially milled bound aggregate. In a further embodiment, the engineering construction further comprises a partially milled bound aggregate and a levelling course. In a yet further embodiment, the engineering construction further comprises a base course, a partially milled bound aggregate, and a levelling course. In a still further embodiment, the engineering construction further comprises a subgrade, a base course, a partially milled bound aggregate, and a levelling course. In an alternative embodiment, the engineering construction further comprises a subgrade and a base course. In the preceding embodiments, the at least one additional layer may be located below the multiaxial geogrid and/or the additional layers may be arranged in the order provided (with the earliest mentioned additional layer being lowermost). The engineering construction may further comprise a surface coating, such as a tack coat, between the geogrid and the at least one additional layer. In embodiments comprising multiple additional layers, the surface coating may be located between the uppermost additional layer and the geogrid.

In any of the above uses, the bound aggregate layer may comprise asphalt concrete.

In any of the above uses, the particle size of the aggregate may be in the range of 5 to 35 mm, preferably 10 to 32 mm. Alternatively, the particle size of the aggregate may be up to 11 mm, up to 16 mm, up to 22 mm, or up to 32 mm.

In any of the above uses, the average distance between the multiaxial geogrid and a surface of the aggregate is in the range of 300 to 60 mm, preferably 250 mm to 60 mm, more preferably 200 mm to 60 mm, yet more preferably 150 to 60 mm, most preferably 100 mm to 60 mm.

### BRIEF DESCRIPTION OF THE DRAWINGS

FIG. 1 shows a schematic of the engineering construction according to the present invention. The layers (from top to bottom) are: a binder course of an asphalt concrete, a multiaxial polymer geogrid, a levelling course of an asphalt concrete, a partially milled asphalt concrete, an unbound base course, and subgrade.

FIG. 2A shows a schematic of a side on view of an asphalt concrete beam according to the present invention. The beam has a length, L, a depth, H, and a width, not depicted in the figure, and is substantially constant in composition along its length and across its width, but varies in composition through its depth, being formed of different layers. The layers (from top to bottom) are: a binder course of an asphalt concrete, a multiaxial polymer geogrid to which a geotextile is affixed, and levelling course of an asphalt concrete.

FIG. 2B shows a schematic of a side on view of a comparative asphalt concrete beam (i.e. without a multiaxial geogrid). The beam has a length, L, a depth, H, and a width, not depicted in the figure, and is substantially constant in composition along its length and across its width, but varies in composition through its depth, being formed of different layers. The layers (from top to bottom) are: a binder course of an asphalt concrete and a levelling course of an asphalt concrete.

FIG. 3 shows a schematic of a side on view of the 4 Point Bending apparatus used to evaluate the concrete beams, showing the locations of the contact points on the beam. The upper points are separated by distance A (247 mm) and the lower points are separated by distance B (740 mm). Force is applied to the beam as indicated by arrow F. The beams tested had a length L (850 mm), width S (170 mm) and a height H (100 mm).

FIG. 4 shows the relative fatigue life of beams according to the present invention (i.e. including a geogrid) and a comparative beam without a geogrid, as found by the 4 Point Bending test.

### DETAILED DESCRIPTION

### Geogrids

Geogrids are a well-known class of products used stabilise loose materials in construction. In general, geogrids are planar mesh structures comprised of elongate elements (e.g. strands) connected by nodes, with these parts defining the sides and corners of apertures in the geogrid. A number of materials can be used to form geogrids, such as metals, natural fibres, and fibreglass. Polymers are of particular interest in the field due to their beneficial physical characteristics and relatively low cost. Depending on the methods used to create them, the polymers within polymer geogrids may be molecularly orientated, improving their properties, such as tensile strength or stiffness.

Generally, molecular orientation within the polymer is achieved through the stretching of a heated polymer sheet. This may be done to an apertured polymer sheet to simultaneously form the elongate elements and nodes and induce molecular orientation within them.

Uniaxial geogrids possess elongate elements running parallel to a single axis (hence uniaxial) and affixed at each end to a bar, which can be considered a continuous node running across the single axis. The elongate elements usually form a continuous end-to-end run along the length of the geogrid, passing through the bars.

Biaxial geogrids possess elongate elements, each running parallel to one of two axes (hence biaxial). Where the ends of the elongate elements meet, nodes are formed. In general, the elongate elements running parallel to each axis are equally spaced, and the spacing is the same for elongate elements running parallel to each of the two axes. Typically, the axes are perpendicular to one another, resulting in a geogrid with apertures that are rectangular or square in construction. Other angles may be used, resulting in a geogrid with apertures that are a parallelogram or a rhombus in shape.

The geogrids of the present invention are multiaxial geogrids, which are defined herein as geogrids that possess elongate elements, each running parallel to one of at least three axes. For example, triaxial geogrids have elongate elements, each running parallel to one of three axes. In general, the spacing between elongate elements running parallel to each axis is equal, and this spacing is the same for the elongate elements running parallel to each of the three axes. Usually the axes are arranged at mutual 60° angles, such that the elongate elements form equilateral triangles arranged into hexagons. This arrangement permits the geogrid to distribute load more evenly across its structure. Triaxial geogrids and methods for their production are described in WO 2004/003303, incorporated by reference herein.

Geogrids are specified by a large number of parameters, such as:

Product weight, specified in terms of weight per unit area. Typical geogrid product weights are at least preferably of from 0.120 to 0.400 kg/m², more preferably of from 0.150 to 0.350 kg/m², most preferably of from 0.170 to 0.310 kg/m², for example from 0.180 to 0.300 kg/m².

Pitch, geogrids have a repeating structure and the pitch of the geogrid is the dimension of the repeating unit. In a triaxial geogrid, the repeating unit is a hexagon and the distance of the hexagonal pitch is the separation of the parallel sides of the hexagon. The pitch is usually of at least 30 mm, preferably of from 40 to 150 mm, more preferably of from 50 to 140, most preferably of from 65 to 125 mm.

Junction efficiency, being the strength of the node expressed a percentage of the strength of the elongate elements and is indicative of the ability of the geogrid to transfer loads between elongate elements at each node (junction). Suitable junction efficiencies are at least 90% preferably at least 95%, more preferably of at least 97%, most preferably of at least 99%, for example of 100%.

Radial Secant stiffness, which is a measure of the total response of the geogrid to a defined force, including both elastic and inelastic deformation. Usually, the geogrid possesses a radial secant stiffness at 0.5% strain of at least 100 kN/m, preferably of from 200 to 800 kN/m more preferably of from 220 to 700 kN/m, most preferably of from 250 to 600 kN/m. Additionally, or alternatively, the geogrid may have a radial secant stiffness at 2% strain of at least 80 kN/m, preferably of from 150 to 600 kN/m more preferably of from 170 to 500 kN/m, most preferably of from 200 to 450 kN/m. The radial secant stiffness ratio (dimensionless) may be at least 0.5, preferably of from 0.6 to 0.9, most preferably of from 0.70 to 0.85, most preferably of from 0.75 to 0.80.

Geogrids generally possess an inconsistent thickness due to the processes used in their production, with the nodes being thicker than the elongate elements. In some embodiments, geogrids are used which have substantially constant thickness in order to ensure the best possible contact between the geogrid and paving fabric during the thermal bonding process. Multiaxial geogrids with constant thickness and methods for their production are described in WO 2019/058113, incorporated herein by reference.

### Bound Aggregate

The bound aggregate is typically an asphalt concrete, comprising particles of crushed rock held in a solid matrix of bitumen. Alternatively or additionally, the bound aggregate is another composite material, comprising an aggregate and a binder that is suitable for use as a wearing course (i.e. the top course of the engineering construction). The skilled reader will understand that other particulate materials embedded in other binders would receive the same benefits from the present invention as an asphalt concrete.

The particle size of the aggregate is typically in the range of 5 to 35 mm, preferably 10 to 32 mm. Alternatively, the particle size of the aggregate may be up to 11 mm, up to 16 mm, up to 22 mm, or up to 32 mm.

The depth of the bound aggregate required will depend on the purpose and specification of the engineering construction. Generally, the depth of the bound aggregate layer will be 300 mm to 60 mm, with a thicker layer of the bound aggregate being required to support a heavier load. Preferably, the depth of the bound aggregate layer will be 250 mm to 60 mm, more preferably 200 mm to 60 mm, yet more preferably 150 to 60 mm, most preferably 100 mm to 60 mm.

### Geocomposite

In embodiments of the present invention, the geogrid is affixed to a geotextile, such as a paving fabric, and is arranged so that the geogrid is located between the geotextile and the bound aggregate. Typically, the geogrid and geotextile are affixed by thermal bonding, but any suitable technique may be used (e.g. adhesive, solvent welding, ultrasonic welding, and tying).

The geotextile prevents the aggregate particles passing through the geogrid and subsequent lifting of the geogrid during deposition of the asphalt. It is important that the geogrid is kept substantially planar to ensure efficient transfer of forces throughout the geogrid. The geotextile also ensures good contact between the geocomposite and the substrate on which it is deposited, especially important if surface coatings (such as tack coatings) are utilised.

Geotextiles may be made of any suitable material, and are typically polymers such as polypropylene or polyester. The geotextile may be a spunbond or a needlepunched non-woven material, in addition, one or both faces of the geotextile may be calendered, or neither face is calendered.

### Fatigue Life

Fatigue life is a general term for the length of time an object can withstand a given force before failing and is therefore a key parameter for the specification of engineering constructions, such as pavements are road surfaces, as it determines the lifetime of the construction. Fatigue life is defined herein as the number of cycles of loading and unloading the sample can withstand before the detected stiffness modulus, S, has decreased to 50% of the initial stiffness modulus. The fatigue life may be determined using a four point bending test under controlled strain.

Compared to an equivalent engineering construction absent the geogrid, the engineering constructions of the present invention in which the geogrid is at least partially embedded in the bound aggregate layer exhibit improved fatigue life. At 130 microstrain, the fatigue life may be increased by a factor of about 10. At 100 microstrain, the fatigue life may be increased by a factor of about 14. At 70 microstrain, the fatigue life may be increased by a factor of about 22.

### Engineering Construction

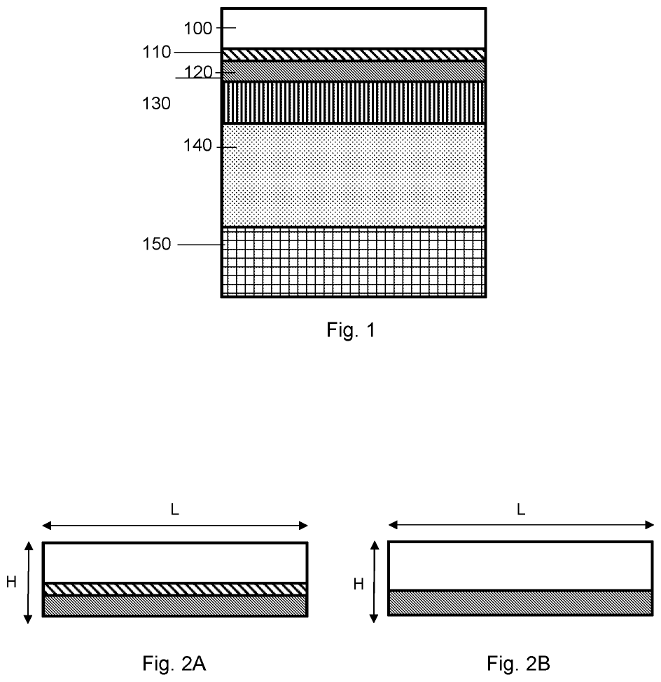

One example of an engineering construction according to the present invention is shown schematically in FIG. 1. The binding course 100 of the composite is an asphalt concrete, itself formed from aggregate embedded in a matrix of bitumen. The binding course 100 has a geocomposite 110 partially embedded in its lower surface.

The geocomposite 110 comprises a triaxial polymer geogrid thermally bonded to a non-woven paving fabric, and is positioned with the geogrid uppermost so that the geogrid is enmeshed in the binding course 100. Enmeshing of the geogrid within the bound aggregate layer means that the particles of the aggregate partially penetrate into the apertures of the geogrid, thereby mechanically interlocking the geogrid and bound aggregate layer and ensuring efficient transfer of forces between them. The highly symmetrical nature of the multiaxial polymer geogrids means that any out-of-plane forces applied to the engineering construction are effectively dispersed throughout its mass via the elongate elements of the geogrid. The geogrid and the non-woven paving fabric are affixed to one another by thermal bonding, although any other suitable technique may be used, for example gluing, ultrasonic welding, or tying.

The thickness of the binding course 100 can be selected depending on the requirements of its application. Generally, the thickness will vary from 300 to 60 mm. In some applications, the thickness of the binding course 100 is reduced compared to that of an unsupported binding course in the same application, while maintaining the same fatigue life. This advantageously reduces the quantity of asphalt concrete required to form the engineering construction. In some applications, the thickness of the binding course 100 is comparable to that of an unsupported binding course in the same application, resulting in an improved fatigue life of the engineering construction. This advantageously extends the lifetime of the engineering construction. In some applications, the thickness of the binding course 100 is reduced compared to that of an unsupported binding course in the same application while also improving the fatigue life of the engineering construction.

This advantageously reduces the quantity of asphalt concrete required while also extending the lifetime of the engineering construction.

Geogrids generally possess an inconsistent thickness due to the processes used in their production. In some embodiments, geogrids are used which have substantially constant thickness in order to ensure the best possible contact between the geogrid and paving fabric during the thermal bonding process. Multiaxial geogrids with constant thickness and methods for their production are described in WO 2019/058113, incorporated by reference herein.

A number of optional sublayers may be included in the engineering construction to enhance its properties and/or to compensate for suboptimal geometry. In some cases, these sublayers may be provided specifically for the engineering construction of the present invention. In other cases, these sublayers may be remnants from a previous engineering construction that is being replaced by the engineering construction of the present invention.

A first optional sublayer, below the geocomposite 110, is a levelling course 120. Such courses are used to ensure that a level surface is provided on which the geocomposite and binding course can be applied. Distortions within the substrate on which the geogrid is placed will reduce the planarity of the geogrid, thereby reducing its efficiency in transferring forces and can result in lower shear strength between the layers. In particular, gaps in the substrate directly below the geogrid and binding course can result in reflection cracking.

A second optional sublayer, below the geocomposite 110, is a partially milled pre-existing asphalt concrete course 130. It is common for asphalt concrete to require refurbishment and/or replacement. To do this, the existing asphalt course is removed using one of a number of milling processes to expose the supporting layers beneath. In certain settings, it is preferred to only partially mill the existing asphalt concrete course, leading to the presence of a partially milled asphalt concrete course 130.

Third and fourth optional sublayers, below the geocomposite 110, are a base course 140 and a subgrade 150. These layers comprise aggregate that is compacted, usually without a binder, to provide a level and solid surface for the asphalt concrete to be deposited onto. The need for, and required features of, these layers depends on the function of the engineering construction and the underlying geology.

Surface treatments may be present between any of these layers as desired. Typically, a tack coating is applied to the sublayer directly below the geocomposite to ensure good adhesion of the geogrid and/or paving fabric to the sublayer, thereby increasing the shear strength of the interface. Tack coatings are typically applied at an elevated temperature of between about 55 and about 90° C., preferably between about 65 and 85° C., and more preferably between about 65 and 80° C. Tack coatings may be bitumen emulsions, in particular cationic bitumen emulsions. Typically the cationic bitumen emulsion comprises bitumen as the binder, but it may comprise polymer modified bitumen. The bitumen within the emulsion may be any suitable bitumen, but is preferably has a penetration power at 25° C. (as determined by BS EN 12849:2009) of between about 100 and about 220, preferably between about 100 and about 180, or most preferably between about 100 and about 150. Typically the cationic bitumen emulsion has a breaking value (as determined by BS EN 13075-1:2016 or BS EN 13075-2:2016 as appropriate) from about 70 to about 155 g/100 g, preferably between about 80 to about 150 g/100 g, and more preferably between about 90 to about 135 g/100 g, for example from about 100 to about 120 g/100 g. Cationic bitumen emulsions may have a bitumen content of between about 60 and about 75 wt %, preferably between about 63 to about 71 wt %, more preferably between about 65 to about 70 wt %, most preferably between about 67 and about 69 wt %, for example, 69 wt %.

### Production of the Engineering Construction

An exemplary method for producing an engineering construction is outlined below. This example relates to the production of an engineering construction wherein the bound aggregate is an asphalt concrete comprising aggregate and a bituminous binder. The skilled person will understand that this method may be adapted for the production of engineering constructions comprising other bound aggregates, such as aggregates and liquid polymer binders.

A geocomposite comprising a multiaxial polymer geogrid thermally bound to a non-woven is deposited on a substrate, such as one of the optional sublayers described above, with the geogrid uppermost. Usually, the engineering construction is manufactured in situ, that is the geogrid is placed at the intended location of the engineering construction and the engineering construction built there. However, it will be understood that it will be preferable in some situations to ‘pre-cast’ the engineering construction elsewhere (e.g. using a mould), and deliver the completed engineering construction to the intended location.

The unbound aggregate is then deposited onto the geogrid to embed the geogrid into the aggregate layer. The unbound aggregate typically comprises the aggregate and an unset binder, although in certain cases the unset binder may be added once the aggregate has been deposited. The bound aggregate is an asphalt concrete comprising aggregate and bitumen whose viscosity has been lowered to render it liquid or semi-solid, enabling the asphalt concrete to flow. This can be achieved in a number of ways such as increasing the temperature of the bitumen, thinning the bitumen with solvent, and/or emulsifying the bitumen in water.

In most applications, the aggregate and unset binder will then be compacted to ensure good contact with the geocomposite and to remove at least a portion of any voids in the asphalt concrete prior to binding. The compaction also leaves a smooth surface on the bound aggregate.

The aggregate layer, with embedded geogrid, is then bound by setting the binder. This process varies depending on how the viscosity of the bitumen was reduced. For example, in the ‘hot’ asphalt concrete process, the asphalt concrete is simply allowed to cool, solidifying the bitumen and binding the aggregate. In the solvent and emulsion-based asphalt concrete processes, the solvent and/or water is allowed to evaporate to achieve the same result. In some embodiments, setting the binder and compaction can take place simultaneously.

### Improvement of Engineering Construction Fatigue Life

An exemplary method of improving the fatigue life of an engineering construction is disclosed herein. By at embedding a multiaxial polymer geogrid in an aggregate prior to binding the aggregate, the resulting engineering construction, specifically the bound aggregate layer thereof, has an improved fatigue life compared to an equivalent engineering construction in which no multiaxial polymer geogrid is embedded.

Multiaxial polymer geogrids may be used to improve the fatigue life of an engineering construction by being embedded in a bound aggregate layer that comprises the engineering construction.

Embedding the geogrid into the bound aggregate increases the fatigue life of the bound aggregate layer compared to a bound aggregate without a multiaxial polymer geogrid embedded within it. This advantageously increases the time between repair and/or resurfacing operations. Without wishing to be bound by theory, it is believed that the use of a multiaxial polymer geogrid enables a more isotropic in-plane distribution of loads applied to the surface of the engineering construction. This in turn reduces the stress applied to any one part of the engineering construction, improving its fatigue life.

### Reduction of Engineering Construction Depth

An exemplary method of reducing the depth of an engineering construction is disclosed herein. By embedding a multiaxial polymer geogrid in an aggregate prior to binding the aggregate, the resulting engineering construction, specifically the bound aggregate layer thereof, has a reduced thickness when compared to a engineering construction in which no multiaxial polymer geogrid is embedded, while maintaining a fatigue life at least equal to the fatigue life of the engineering construction in which no multiaxial polymer geogrid is embedded.

Multiaxial polymer geogrids may be used to reduce the depth of an engineering construction by being embedded in a bound aggregate layer that comprises the engineering construction. By embedding the multiaxial polymer geogrid in a bound aggregate layer, the fatigue life of the engineering construction comprising the bound aggregate layer is improved. The fatigue life of a bound aggregate layer is proportionate to its depth. Therefore, the use of a geogrid allows the depth of the bound layer to achieve a desired fatigue life to be reduced compared to the depth of the bound layer required to achieve the same fatigue life in the absence of the multiaxial polymer geogrid.

For each of the above, the reduction in depth reduces the quantity of bound aggregate required, thereby reducing material cost and energy required to form the engineering construction.

### Examples

The invention will now be explained with reference to the follow examples. It will be understood that these examples are merely illustrative of the invention and are not intended to be limiting.

### Sample Preparation

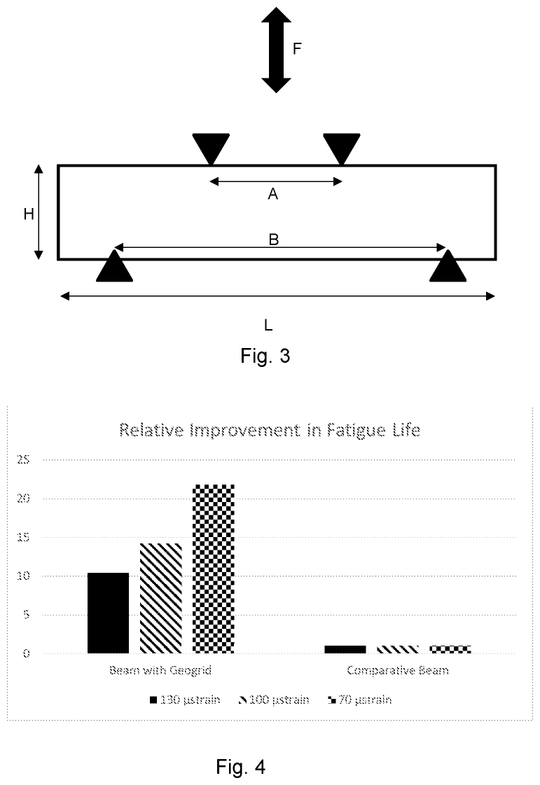

Sample beams of asphalt concrete, as schematically depicted in FIGS. 2A and 2B, with lengths of 850 mm, widths of 170 mm, and thicknesses of 100 mm were prepared as described below.

A 30 mm levelling course of AC 11W 35/50 was deposited and allowed to set. This asphalt concrete had a maximum aggregate size of 11 mm and the bitumen had a penetration value of 35/50. The properties of this asphalt concrete are set out in Table 1.

TABLE 1
The physical properties of AC 11W 35/50

| Property | Test method | Value |
|---|---|---|
| Density (Mg/m³) | PN-EN 12687-5:2019, | 2.480 |
| | method A, in water | |
| Bulk Density (Mg/m³) | PN-EN 12697-6:2012, method B, | 2.365 |
| | saturated surface dry | |
| Air voids, Vₘ (%) | PN-EN 12697-8:2019, section 4 | 4.6 |
| Voids filled with | PN-EN 12697-8:2019, section 5 | 70.9 |
| bitumen, VFB (%) | | |
| Voids in mineral | PN-EN 12697-8:2019, section 5 | 15.8 |
| aggregate, VMA (%) | | |
| Resistance to permanent | PN-EN 12697-22 + A1:2008, small | 0.12 |
| deformation-Wheel tracking | device, method B in air | |
| speed (WTS) | | |
| Resistance to permanent | PN-EN 13108-20, D.1.6, 60° C., | 5.6 |
| deformation-Proportional rut | 10,000 cycles | |
| depth (PRD) | | |
| Water sensitivity-Indirect | PN-EN 12697-12:2018, conditioned | 84 |
| tensile strength | at 40° C. with one freezing cycle, | |
| ratio (ITSR) (%) | tested at 25° C. | |

A geocomposite comprising a geogrid fixed to a paving fabric was provided. The geogrid was a triaxial polypropylene geogrid with ribs running in the machine direction, the characteristics of which are set out in Table 2.

TABLE 2
The physical properties of the triaxial geogrid used
(MD-machine direction; CMD-cross-machine direction)

| Property | | |
|---|---|---|
| (Test method) | Unit | Value |
| Tensile Strength | kN/m | MD-16 |
| (EN ISO 10319) | | CMD-20 |
| Elongation at Maximum Load | % | MD-11 |
| (EN ISO 10319) | | CMD-11 |
| Melting Point | ° C. | 162 |
| (EN 3146) | | |

The paving fabric was a non-woven paving fabric, the characteristics of which are set out in Table 3.

TABLE 3
The physical properties of the non-woven paving fabric

| Property | | |
|---|---|---|
| (Test method) | Unit | Value |
| Static Puncture Resistance (CBR test) | kN/m | 1.2 |
| (EN ISO 12236) | | |
| Dynamic Perforation Resistance (cone | mm | 23 |
| drop test) | | |
| (EN ISO 13433) | | |
| Bitumen Retention | kg/m² | 1.5 |

In this example, the geogrid and paving fabric were affixed using thermal bonding to provide a geocomposite. The skilled person will understand that other multiaxial polymer geogrids, paving fabrics and fixing methods may be used without departing from the scope of the present invention.

A tack coat based on bitumen emulsion C69 B3 PU was applied to the surface of the levelling course and the geocomposite was placed on the levelling course with the paving fabric proximate to the surface of the levelling course. Bitumen emulsion C69 B3 PU is a cationic emulsion used for surface treatments with a bitumen content of 69%.

The pitch of the geogrid was 80 mm, ensuring that the sample included a minimum of two full repeating pitches across the 170 mm width of the beam.

A 70 mm binder course comprising AC 16W 35/50 was paved onto the geogrid and allowed to set. This asphalt concrete had a maximum aggregate size of 16 mm and the bitumen had a penetration value of 35/50. The properties of this asphalt concrete are set out in Table 4.

TABLE 4
The physical properties of AC 16W 35/50

| Property | Test method | Value |
|---|---|---|
| Density (Mg/m³) | PN-EN 12687-5:2019, method A, | 2.544 |
| | in water | |
| Bulk Density (Mg/m³) | PN-EN 12697-6:2012, method B, | 2.430 |
| | saturated surface dry | |
| Air voids, Vₘ (%) | PN-EN 12697-8:2019, section 4 | 4.5 |
| Voids filled with | PN-EN 12697-8:2019, section 5 | 70.5 |
| bitumen, VFB (%) | | |
| Voids in mineral | PN-EN 12697-8:2019, section 5 | 15.2 |
| aggregate, VMA (%) | | |
| Resistance to permanent | PN-EN 12697-22 + A1:2008, small | 0.10 |
| deformation-Wheel | device, method B in air | |
| tracking speed (WTS) | | |
| Resistance to permanent | PN-EN 13108-20, D.1.6, 60° C., | 5.3 |
| deformation-Proportional | 10,000 cycles | |
| rut depth (PRD) | | |
| Water sensitivity- | PN-EN 12697-12:2018, | 93 |
| Indirect tensile | conditioned at 40° C. with one | |
| strength ratio (ITSR) (%) | freezing cycle, tested at 25° C. | |

A comparative asphalt concrete beam was prepared using the same methodology and materials, omitting the geocomposite.

### Fatigue Four Point Bending Test

A four point bending apparatus was used to carry out strain controlled fatigue testing at a temperature of approximately 13° C. and a schematic of the testing apparatus is shown in FIG. 3. Static contact points are provided below the beam at a separation of 740 mm and dynamic contact points are provided above the beam at a separation of 247 mm. The beam to be tested was inserted into the apparatus with the levelling course uppermost, with the centre of the beam being equidistant from each of the static contact points and each of the dynamic contact points.

Force was then applied to the beam via the dynamic contact points until a desired strain was applied and the initial stiffness modulus (Sini) of the beam was recorded. The same strain was then repeatedly applied, measuring the stiffness modulus each cycle. The fatigue life was determined as the point at which the measured stiffness modulus was half that of Sini.

This experiment was performed for both asphalt concrete beams incorporating the triaxial polymer geogrid and the control asphalt beams without a geogrid at strains of 70 μstrain (representative of light traffic), 100 μstrain (representative of medium traffic), and 130 μstrain (representative of heavy traffic).

### Results

As shown in FIG. 4, the inclusion of the triaxial polymer geogrid in the asphalt concrete beam resulted in an unexpectedly large improvement in fatigue life, with 10.4, 14.2 and 21.8-fold increases at strains of 130 μstrain, 100 μstrain, and 70 μstrain respectively, compared to the comparative asphalt concrete beam. These surprising results clearly demonstrate the beneficial effects on fatigue life obtained by incorporating a multiaxial geogrid within a bound aggregate layer. The fact that the fatigue life improved by an order of magnitude at all loadings tested was unexpected and suggests that the improvement in fatigue life will be found for any application of the engineering construction, from applications subject to relatively heavy loadings (such as in roadways) to those subject to lower loadings (such as in footpaths). The improvements in fatigue life on incorporating a multiaxial geogrid also compare favourably with those found for alternative materials (such as biaxial geogrids, biological materials, and fibreglass) discussed in the background section of this patent.

1. An engineering construction comprising an integral multiaxial polymer geogrid at least partially embedded in a bound aggregate layer, wherein a geotextile is affixed to the geogrid.

2. The engineering construction of claim 1 wherein the geogrid is a triaxial geogrid.

3. The engineering construction of claim 1 or claim 2, wherein the geogrid has radial secant stiffness at 0.5% strain of at least 100 kN/m.

4. The engineering construction of any preceding claim, wherein the geogrid has radial secant stiffness at 2% strain of at least 80 kN/m.

5. The engineering construction of any preceding claim, wherein the geogrid has radial secant stiffness ratio (dimensionless) of at least 0.5.

6. The engineering construction of any preceding claim, wherein the geogrid has junction efficiency of at least 90%.

7. The engineering construction of any preceding claim, wherein the geogrid has pitch (preferably hexagon pitch) of at least 30 mm.

8. The engineering construction of any preceding claim, wherein the geogrid has product weight of at least 0.100 kg/m².

9. The engineering construction of any preceding claim, wherein the geogrid has a substantially constant thickness.

10. The engineering construction of any preceding claim, wherein an axis to which elongate elements comprising the geogrid run parallel to extends in the machine direction.

11. The engineering construction of any preceding claim further comprising at least one additional layer selected from a subgrade, a base course, a pre-existing bound aggregate (which may be partially milled), and a levelling course.

12. The engineering construction of claim 11, wherein the at least one additional layer is located below the multiaxial geogrid.

13. The engineering construction of claim 10 or claim 11, further comprising a surface coating, such as a tack coat, between the geogrid and the at least one additional layer.

14. The engineering construction of any preceding claim, wherein the bound aggregate layer comprises asphalt concrete.

15. The engineering construction of any preceding claim, wherein the particle size of the aggregate is in the range of 5 to 35 mm.

16. The engineering construction of any preceding claim, wherein the average distance between the multiaxial geogrid and a surface of the aggregate is in the range of 300 to 60 mm.

17. A method of producing an engineering construction comprising the steps of:
a) providing an integral multiaxial polymer geogrid to which a geotextile is affixed on a substrate;
b) depositing an aggregate layer to at least partially embed the geogrid in the aggregate layer; and
c) binding the aggregate layer to form a bound aggregate layer in which the geogrid is at least partially embedded.

18. A method of providing an engineering construction exhibiting an improved fatigue life by at least partially embedding an integral multiaxial polymer geogrid to which a geotextile is affixed in an aggregate prior to binding the aggregate to form a bound aggregate layer comprising the engineering construction.

19. A method of providing an engineering construction of a reduced depth by at least partially embedding an integral multiaxial polymer geogrid to which a geotextile is affixed in an aggregate prior to binding the aggregate to form a bound aggregate layer comprising the engineering construction.

20. The method of any one of claims 17 to 19, wherein the geogrid is a triaxial geogrid.

21. The method of any one of claims 17 to 20, wherein the geogrid has radial secant stiffness at 0.5% strain of at least 100 kN/m.

22. The method of any one of claims 17 to 21, wherein the geogrid has radial secant stiffness at 2% strain of at least 80 kN/m.

23. The method of any one of claims 17 to 22, wherein the geogrid has radial secant stiffness ratio (dimensionless) of at least 0.5.

24. The method of any one of claims 17 to 23, wherein the geogrid has junction efficiency of at least 90%.

25. The method of any one of claims 17 to 24, wherein the geogrid has pitch (preferably hexagon pitch) of at least 30 mm.

26. The method of any one of claims 17 to 25, wherein the geogrid has product weight of at least 0.100 kg/m².

27. The method of any one of claims 17 to 26, wherein the geogrid has a substantially constant thickness.

28. The method of any one of claims 17 to 27, wherein an axis to which elongate elements comprising the geogrid run parallel to extends in the machine direction.

29. The method of any one of claims 17 to 28, wherein at least one additional layer selected from a subgrade, a base course, a pre-existing bound aggregate (which may be partially milled), and a levelling course is provided.

30. The method of claim 29, wherein the at least one additional layer is provided below the multiaxial geogrid.

31. The method of claim 29 or claim 30, further comprising providing a surface coating, such as a tack coat, between the geogrid and the at least one additional layer.

32. The method of any one of claims 17 to 31, wherein the bound aggregate layer comprises asphalt concrete.

33. The method of any one of claims 17 to 32, wherein the particle size of the aggregate is in the range of 5 to 35 mm.

34. The method of any one of claims 17 to 32, wherein the average distance between the multiaxial geogrid and a surface of the aggregate is in the range of 300 to 60 mm.

35. Use of an integral multiaxial polymer geogrid to which a geotextile is affixed to improve the fatigue life of an engineering construction, the engineering construction comprising the multiaxial polymer geogrid at least partially embedded in a bound aggregate layer.

36. Use of an integral multiaxial polymer geogrid to which a geotextile is affixed to reduce the depth of an engineering construction, the engineering construction comprising the multiaxial polymer geogrid at least partially embedded in a bound aggregate layer.

37. The use of claim 35 or claim 36, wherein the geogrid is a triaxial geogrid.

38. The use of any one of claims 35 to 37, wherein the geogrid has radial secant stiffness at 0.5% strain of at least 100 kN/m.

39. The use of any one of claims 35 to 38, wherein the geogrid has radial secant stiffness at 2% strain of at least 80 kN/m.

40. The use of any one of claims 35 to 39, wherein the geogrid has radial secant stiffness ratio (dimensionless) of at least 0.5.

41. The use of any one of claims 35 to 40, wherein the geogrid has junction efficiency of at least 90%.

42. The use of any one of claims 35 to 41, wherein the geogrid has pitch (preferably hexagon pitch) of at least 30 mm.

43. The use of any one of claims 35 to 42, wherein the geogrid has product weight of at least 0.100 kg/m².

44. The use of any one of claims 35 to 43, wherein the geogrid has a substantially constant thickness.

45. The use of any one of claims 35 to 44, wherein an axis to which elongate elements comprising the geogrid run parallel to extends in the machine direction.

46. The use of any one of claims 35 to 43, wherein the engineering construction further comprises at least one additional layer selected from a subgrade, a base course, a pre-existing bound aggregate (which may be partially milled), and a levelling course.

47. The use of claim 46, wherein the at least one additional layer is located below the multiaxial geogrid.

48. The use of claim 46 or claim 47, wherein the engineering construction further comprising a surface coating, such as a tack coat, between the geogrid and the at least one additional layer.

49. The use of any one of claims 35 to 48, wherein the bound aggregate layer comprises asphalt concrete.

50. The use of any one of claims 35 to 49, wherein the particle size of the aggregate is in the range of 5 to 35 mm.

51. The use of any one of claims 35 to 50, wherein the average distance between the multiaxial geogrid and a surface of the aggregate is in the range of 300 to 60 mm.
